(19) United States
(12) Patent Application Publication
(10) Pub. No.: US 2011/0276959 A1
(43) Pub. Date: Nov. 10, 2011

(54) INFORMATION PROCESSING APPARATUS, INSTALLATION SYSTEM, INFORMATION PROCESSING METHOD, AND INSTALLATION METHOD

(75) Inventor: Makoto Kobayashi, Tokyo (JP)

(73) Assignee: CANON KABUSHIKI KAISHA, Tokyo (JP)

(21) Appl. No.: 13/096,797

(22) Filed: Apr. 28, 2011

(30) Foreign Application Priority Data
May 6, 2010 (JP) 2010-106474

(51) Int. Cl. G06F 9/445

(52) U.S. Cl. 717/174

(57) ABSTRACT

An information processing apparatus useful in simplifying installation operations performed by an installation operator and preventing interpolation, by a third person, of a range of a value to be set for a parameter of an application to be installed includes a confirmation unit configured to confirm correctness of definition information included in application data, a display unit configured to display a screen used by an installation operator for setting the value of the parameter based on the definition information if correctness of the definition information is confirmed by the confirmation unit, a validity confirmation unit configured to, if the value is set for the parameter via a screen, confirm the validity of the parameter value based on the definition information, and a transmission unit configured to transmit, if the validity of the value of the parameter is confirmed, the application data and the value of the parameter.

### BACKGROUND OF THE INVENTION

1. Field of the Invention

The present invention relates to an information processing apparatus, an installation system, an information processing method, and an installation method.

2. Description of the Related Art

Conventional verification of a setting value of an application program is performed by storing setting information of an application user interface (UI) in advance in a storage unit of an information processing apparatus. Then, the information processing apparatus compares the setting information and setting information obtained as a result of a UI change operation performed by a user. The setting value is examined in this manner (see Japanese Patent Application Laid-Open No. 2009-205353).

In installing an application that runs on a multi function peripheral (MFP), it is convenient for users to be able to install the application after making specific setting (network setting, application parameter setting, or the like) of the application. Such a demand may be realized, for example, if an installation operator prepares a setting file of the application, and installs the application and the file at the same time.

However, regarding such a method, if an agreement regarding the description of the setting file is not made in advance, the format of the setting file may be different for each application.

Similarly, since the setting methods of the setting values are generally different according to the application, the setting methods will be lacking uniformity for the installation operators who install various types of applications. Further, since a setting value of an application influences the behavior of the application, the range and the type of the setting values need to be protected from interpolation by a third person.

### SUMMARY OF THE INVENTION

An aspect of the present invention is directed to an information processing apparatus, an installation system, an information processing method, and an installation method capable of simplifying an installation operation by an installation operator and preventing interpolation by a third person of, for example, a range of a value which is set for a parameter of an application to be installed.

According to an aspect of the present invention, an information processing apparatus includes a confirmation unit configured to confirm, when application data including a parameter of an application with definition information of a value of a parameter and an encrypted application whose behavior can be changed according to the value of the parameter and operates on an image processing apparatus are registered, correctness of the definition information included in the application data, a display unit configured to, if the correctness of the definition information is confirmed by the confirmation unit, display a screen used by an installation operator of the application for setting the value to the parameter according to the definition information, a validity confirmation unit configured to confirm validity of the value of the parameter based on the definition information if the value is set to the parameter via the screen, and a transmission unit configured to transmit the application data and the value of the parameter if validity of the value of the parameter is confirmed by the validity confirmation unit.

According to another aspect of the present invention, an installation operation performed by an installation operator is simplified and interpolation by a third person of, for example, a range of a value which is set for a parameter of an application to be installed can be prevented.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an example of a system configuration of an installation system.

FIG. 2 illustrates an example of a hardware configuration of a personal computer (PC).

FIG. 3 illustrates an example of a hardware configuration of an MFP.

FIG. 4 illustrates an example of a software configuration of the MFP.

FIG. 5 illustrates an example of a format of an MFP application.

FIG. 6 (6A and 6B) is a flowchart illustrating an example of processing performed by an MFP application installer that operates on the PC.

FIG. 7 illustrates an example of a second End User License Agreement (EULA) and schema of setting parameters in a parameter setting parameter unit for setting various kinds of settings.

FIG. 8 illustrates an example of a setting file.

FIG. 9 is a flowchart illustrating an example of processing performed by an installer that operates on the MFP.

### DESCRIPTION OF THE EMBODIMENTS

Various exemplary embodiments, features, and aspects of the invention will be described in detail below with reference to the drawings.

### <System Configuration>

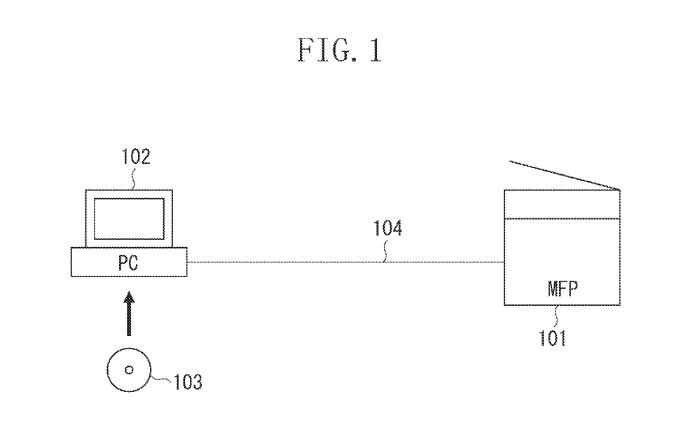

FIG. 1 illustrates an example of a system configuration of an installation system. A MFP 101 includes functions of a copying machine, a printer, an image scanner, and a facsimile machine. A PC 102 includes a network interface and a browser application. A common operating system runs on the PC 102. According to the present exemplary embodiment, the MFP is an example of an image processing apparatus.

A network 104 mutually connects the MFP 101 and the PC 102 by a Transmission Control Protocol/Internet Protocol (TCP/IP) or the like. A MFP application 103 is an application that runs on the MFP 101. The MFP application 103 is given an electronic signature by a distribution source of the application using digital signature algorithm (DSA) and is encrypted by advanced encryption standard (AES) algorithm. A user (installation operator) who installs the MFP application 103 on the MFP 101 registers the MFP application 103 with a MFP application installer that operates on the PC 102.

After the registration, by using the MFP application installer, the user confirms the EULA of the MFP application 103. The EULA is an example of license agreement information of the MFP application 103. After setting an initial value of the MFP application 103, the MFP application installer transmits the MFP application 103 to the MFP 101 via the network 104. Details of the processing will be described below.

### <Schematic Hardware Configuration of PC 102>

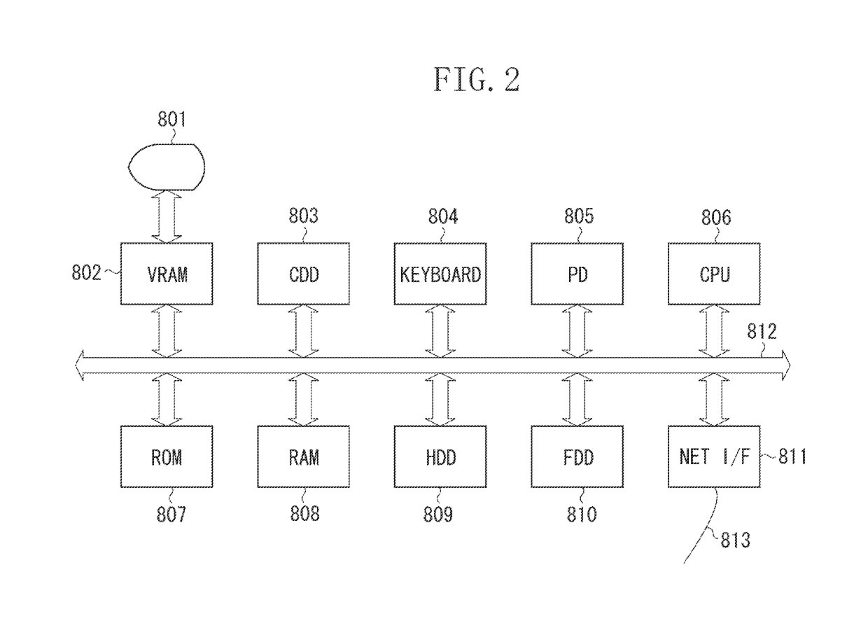

FIG. 2 illustrates an example of a hardware configuration of the PC 102. The MFP application installer is an application that operates on the PC 102. A display device 801 displays, for example, a window, an icon, a message, a menu, and other user interface information of the MFP application installer. A video random access memory (VRAM) 802 stores image data to be displayed on the display device 801.

The image data stored in the VRAM 802 is transferred to the display device 801 according to a predetermined rule. Accordingly, an image is displayed on the display device 801. A compact disk drive (CDD) 803 is a device used for reading and writing of various control programs and data between the PC and a recording media such as a compact disc read-only memory (CD-ROM) or a CD-recordable (CD-R). The CDD 803 can also be a digital versatile disc (DVD). The program of the MFP application installer can be stored in advance in a hard disk drive (HDD) 809 or can be installed from the CDD 803.

A keyboard 804 includes various keys used for inputting characters. A pointing device (PD) 805 is used for pointing, for example, an icon, a menu, or an object, which is displayed on a display screen of the display device 801, regarding the MFP application installer. A central processing unit (CPU) 806 controls each device connected to the CPU based on a control program stored in a read-only memory (ROM) 807, the HDD 809, a flexible disk drive (FDD) 810 or the CDD 803.

The function (software) of the PC 102 and processing related to the flowchart performed by the PC 102 described below are realized by the CPU 806 executing processing based on the program. In the following description, the processing of the flowcharts is described as executed by the MFP application installer so as to simplify the description.

The ROM 807 stores various control programs and data. A random access memory (RAM) 808 includes a work area of the CPU 806, a data saving area when an error is handled, and a loading area of a control program.

The HDD 809 stores various control programs and various types of data. A NET I/F 811 is a network interface. The PC 102 can communicate with another information processing apparatus or a printer via a network 813 by using the NET I/F 811. The MFP application installer communicates with the MFP 101 via the NET I/F 811 and the network 813, and installs the MFP application.

A CPU bus 812 includes an address bus, a data bus, and a control bus. A control program can be provided to the CPU 806 from the ROM 807, the HDD 809, the FDD 810, or the CDD 803, or further, from another information processing apparatus via the network 813.

### <Schematic Hardware Configuration of MFP 101>

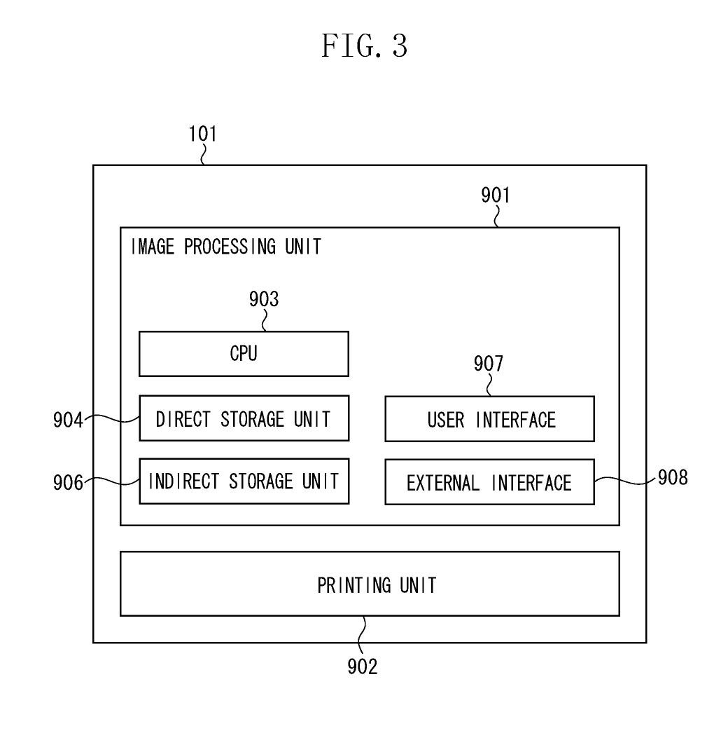

FIG. 3 illustrates an example of a hardware configuration of the MFP 101. The MFP 101 includes an image processing unit 901 and a printing unit 902. The image processing unit 901 includes a CPU 903, a direct storage unit 904, an indirect storage unit 905, a user interface 907, and an external interface 908.

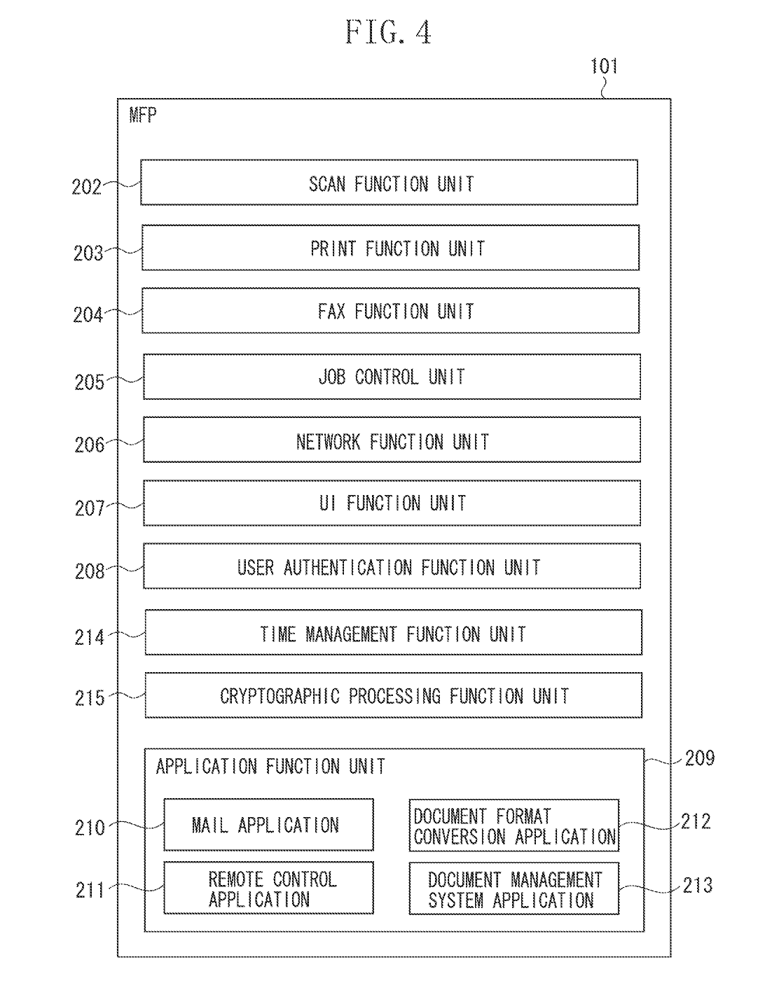

When the CPU 903 of the image processing unit 901 executes a program stored in the indirect storage unit 905, software components 202, 204, 206, 207, 208, 209, 214, and 215 in FIG. 4 described below are realized. Further, by a CPU of the printing unit 902 executing a program stored in a storage unit of the printing unit, software components 203 and 205 in FIG. 4 described below are realized.

The CPU 903 executes a predetermined program and gives instructions regarding control of the MFP 101. The direct storage unit 904 is a work memory which is used by the CPU 903 when the CPU executes a program. The program executed by the CPU 903 is loaded onto the direct storage unit 904. The direct storage unit 904 is a RAM. The indirect storage unit 905 stores various programs including an application program and a platform program.

The various programs stored in the indirect storage unit 905 are transferred to the direct storage unit 904 when the CPU 903 executes a program. The indirect storage unit 905 is a solid state drive (SSD) or a HDD. The CPU 903 can also be a multiprocessor.

Next the platform will be described in detail. According to the platform, a new application developed by the user can be executed on the MFP 101, and further, the operation screen of the MFP 101 can be customized.

Next, a realization method of the platform will be described. The CPU 903 transfers a platform program stored in the indirect storage unit 905 to the direct storage unit 904. When the platform program is transferred, the CPU 903 can execute the program.

According to the present exemplary embodiment, when the CPU 903 executes the platform program, it is described that the platform is activated. The platform operates on firmware of the MFP 101. The platform program provides an environment on which an object-oriented application program is executed.

Next, a method for executing an application program on the platform will be described in detail. According to the present exemplary embodiment, printing software that accepts a print request runs on the platform. From a device which is connected to the printing software via a network, the printing software can receive print data by using a communication protocol such as Hyper Text Transfer Protocol (HTTP).

The printing software transmits the received print data to the firmware, and the firmware that received the print data starts processing of the print data. If the print data can be printed without processing it, the firmware does not process the print data. As described above, the MFP 101 can be controlled according to execution of the application program on the platform.

Next, the execution method of the application program will be described. The activated platform transfers the application program stored in the indirect storage unit 905 to the direct storage unit 904. When the application program is transferred, the platform can execute the application program.

Then, the platform executes the application program. According to the present exemplary embodiment, a function of the platform that can be provided according to execution of the application program is called as a platform application. Further, the platform can execute a part of the processing of the flowcharts of the present exemplary embodiment.

The installer that operates on the MFP 101 also operates as a part of the application program. The installer that operates on the MFP 101 can communicate with the PC 102 via the network 104 by using a HTTP protocol. The installer that operates on the MFP 101 can install the MFP application 103 through communication.

The user interface 907 is a unit necessary in accepting a processing request sent from the user. For example, the user interface 907 accepts a signal corresponding to an instruction input by the user via an operation panel. The external interface 908 is used for receiving data from and transmitting data to an external apparatus.

The external apparatus is, for example, an external storage unit such as an external HDD or an external USB memory, or a different host computer connected via a network or a different image forming apparatus. The MFP 101 can communicate with the PC 102 via the network 104 or the Internet.

The function (software) of the MFP 101 and the processing of the flowchart of the MFP 101 described below are realized by the CPU of the MFP 101 executing processing based on a program stored in a storage unit of the MFP 101. In the following description, the processing of the flowchart is described as executed by the installer (installer that operates on the MFP 101) so as to simplify the description.

### <Schematic Configuration of Software of MFP 101>

FIG. 4 illustrates an example of a software configuration of the MFP 101. A scanner (Scan) function unit 202 converts paper document into scanned binary image data. A print (Print) function unit 203 adds a command for the printer to an image scanned by the scanner function unit 202 and converted into binary image data. Then, the print function unit 203 transmits the image and the command to the printer device.

Further, a facsimile (FAX) function unit 204 performs coding of an image scanned by the scanner function unit 202 and converted into binary image data according to a fax machine standard such as G3 or G4. Further, the facsimile function unit 204 performs image communication with an external fax machine by a protocol of the corresponding facsimile standard.

Further, the facsimile function unit 204 transmits/receives a facsimile image from an external fax machine according to a facsimile standard. The binary image data transmitted from the scanner function unit 202 and facsimile image data which the facsimile function unit 204 received from an external apparatus is queued as a print job by a job control function unit 205.

The job control function unit 205 sequentially outputs a print job to a print function unit 203, the facsimile function unit 204, and a network function unit 206 described below as needed. The network function unit 206 communicates with a different apparatus by using various network protocols such as TCP/IP, Hypertext Transfer Protocol (HTTP), File Transfer Protocol (FTP), Lightweight Directory Access Protocol (LDAP), Simple Network Management Protocol (SNMP), Simple Mail Transfer Protocol (SMTP), and Secure Sockets Layer (SSL).

A user interface (UI) function unit 207 manages input/output performed by a user of the MFP 101 using the operation panel, and displays an input field, an output message field, or other fields on the operation panel. Further, the user interface function unit 207 receives an input value which has been input by the user in the input field, and notifies a different function unit of the input value. Further, the user interface function unit 207 displays a message for the user sent from a different function unit on a screen which has been designed in advance.

A user authentication function unit 208 deals with a user authentication request regarding various applications in an application function unit 209 by using the user interface function unit 207 or an information terminal on the network. In other words, the user authentication function unit 208 sets a user authentication function for each application by using a user authentication setting file. Further, the user authentication function unit 208 performs authentication of the user that uses various functions of the MFP by using a user authentication server on the network or user authentication information in the MFP.

The application function unit 209 installs various applications that run on the MFP 101, performs user authentication, and executes and uninstalls the various applications. Further, the application function unit 209 sets an expiry date of the application when it is installed.

Further, by determining an expiry date, which is set in advance when the application is installed, by using a function of a time management function unit 214 described below when the application is executed, the application function unit 209 realizes an application with an expiry date. The application function unit 209 can store the expiry date information in the application object or set the expiry date information as a different object as additional information of the application when the application is installed.

The expiry date information includes the number of days from when the application is installed to when the use of the application is expired. The expiry date information can be expressed by the number of days of the validity period as is with the present exemplary embodiment but can also be expressed by an expiry date (MM/DD/YY). Even if the expiry date is used, the application function unit 209 calculates the number of days of the validity period according to a system clock in the MFP 101.

Further, the expiry date information can also be expressed in units smaller than a day, for example, a second. The expiry date information in such a case can also be calculated by the application function unit 209 if the unit is within the range of the system internal clock. The expiry date information is passed to an installation time setting function described below as an argument when the application is installed, and stored in a non-volatile storage area of the MFP 101.

The application function unit 209 needs only to install a license key in activating a function of an application if the application main body is already installed on the MFP 101 among the applications on the MFP 101.

In order to use an application on the MFP 101, the application needs to be activated after it is installed. In order to activate the application, normally, a license key which is input via the user interface function unit 207 is used. The license key includes function type information and an ID of the apparatus to be activated. The license key can be input by the network function unit 206 via the network.

The application is activated when a license key is input in the MFP 101. Actually, the application function unit 209 turns on a license bit corresponding to each application and stored in the non-volatile storage area in the MFP.

Similarly, the application function unit 209 can invalidate the corresponding application by turning off the above-described license bit.

A mail application 210 is one of the applications that operate on the application function unit of the MFP 101. The mail application 210 receives an electronic mail sent from an information terminal on the network by using the network function unit 206. An electronic document is attached to the electronic mail. The electronic document is printed by using the print function unit.

Further, if an electronic document which has been scanned by the scanner function unit 202 is available, the mail application 210 attaches the electronic document to an electronic mail and transmits the electronic mail to a forwarding address set in advance. A remote operation application 211 is one of the applications that operate on the application function unit of the MFP 101.

The remote operation application 211 allows remote operation by displaying an interface on an information terminal on the network by using the user interface function unit 207. The interface is similar to a touch panel displayed on the MFP 101 main body and thus allows remote operations. A document format conversion application 212 is one of the applications that operate on the application function unit of the MFP 101.

The document format conversion application 212 converts electronic data into data in an electronic data format set in advance. To be more specific, the electronic data scanned by the operator by using the scanner function unit 202 and the electronic data transmitted from an information terminal on the network and received by the network function unit 206 is converted by the document format conversion application 212.

A document management system application 213 is one of the applications that operate on the application function unit of the MFP 101. The document management system application 213 stores the electronic data in a document storage location set in advance on the network or in the MFP 101 main body.

To be more specific, the electronic data which has been scanned by the scanner function unit 202 according to the operation of the main body by the operator, and the electronic data which is transmitted from the information terminal on the network and received by the network function unit 206 are stored by the document management system application 213.

The mail application 210, the remote operation application 211, the document format conversion application 212, and the document management system application 213 can perform user authentication. The user authentication is performed when the operator uses the application. The user authentication function unit 208 is used via the application function unit 209 when the user authentication is performed.

The time management function unit 214 includes a system built-in clock and provides a system built-in clock interface to all the function modules of the MFP 101. The system built-in clock interface can be referred and used for time setting by all the function modules of the MFP 101. Further, the time management function unit 214 stores accumulated time difference regarding setting time calculated from when the system is started in a non-volatile storage area such as a flash ROM.

Further, the time management function unit 214 has a time-setting function according to a time synchronization service on the network to which the MFP 101 is connected. The time synchronization service is a service using a protocol defined by Time protocol (RFC 868), Network Time Protocol (NTP) (RFC 1305), or Simple Network Time Protocol (SNTP) (RFC 1769).

Further, the time management function unit 214 includes an installation time setting function which is used to set the time when the application has been installed (described below). Expiry date determination of an application with an expiry date is performed according to the time set by the installation time setting function.

A cryptographic processing function unit 215 includes common cryptographic algorithms such as AES and RC4 (symmetric-key cryptography) and RSA (public-key cryptography). Further, the cryptographic processing function unit 215 includes standard hash algorithms such as SHA-224, SHA-256, SHA-384, and SHA-512.

Furthermore, the cryptographic processing function unit 215 includes common electronic signature algorithms such as the RSA signature scheme, the ElGamal signature scheme, and the DSA signature scheme. Additionally, the cryptographic processing function unit 215 includes functions concerning key generation, signature creation, and signature verification of various electronic signatures, and further includes the X.509 digital certificate processing function.

Further, the cryptographic processing function unit 215 includes an application program interface (API) which is used when each function unit of the apparatus uses a processing function related to encryption. When an electronic signature and an encrypted program are installed in the MFP from the PC, the application function unit 209 decrypts the program to be installed and performs signature verification using the cryptographic processing function unit 215.

### <MFP Application Format>

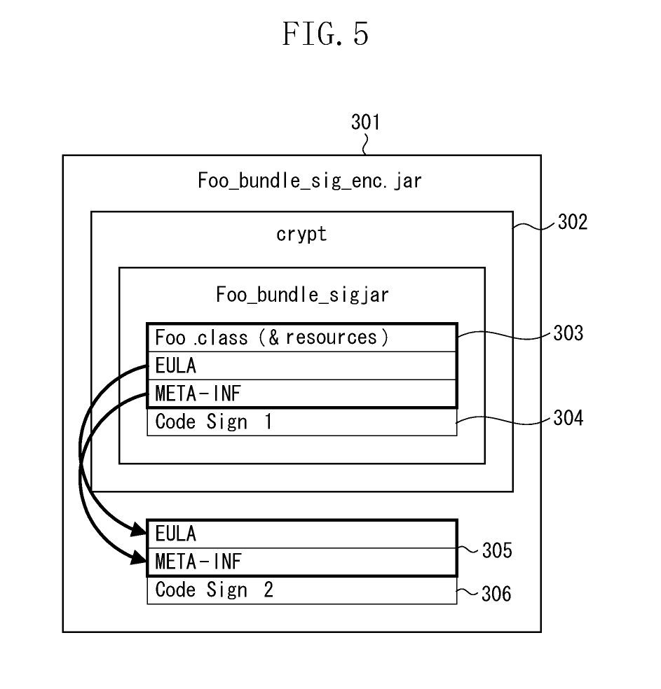

FIG. 5 illustrates an example of a format of the MFP application 103. An MFP application file 301, which is an example of application data, includes an electronic signature and an encrypted signature encryption program main unit 302. The signature encryption program main unit 302 includes a first electronic signature 304. Further, the signature encryption program main unit 302 includes a hash value calculation object unit 303. The hash value calculation object unit 303 includes an MFP program main body unit, a first EULA, and a setting parameter unit.

Further, the MFP application file 301 includes a second EULA of the signature encryption program main unit 302 and a setting parameter unit 305. The second EULA and the setting parameter unit 305 are examples of parameters of an application with definition information of a parameter value.

The content of the second EULA and the setting parameter unit 305 is the same as the content of the EULA and the setting parameter unit included in the hash value calculation object unit 303 included in the first electronic signature. Further, the MFP application file 301 includes a second electronic signature 306 in X.509 digital certificate having the second EULA and the setting parameter unit 305 as a unit to be hashed. The second electronic signature 306 is an example of electronic signature information.

The signature encryption program main unit 302 includes a main body of the MFP application, which has been encrypted by an application issuer by using the AES encryption. The signature encryption program main unit 302 includes the first electronic signature 304 which is electronically signed by an application issuer by using the DSA. The first electronic signature 304 has the MFP application main body, the EULA, and the setting parameter unit as units to be hashed using the DSA signature algorithm.

The first electronic signature 304 is used by the user (installation operator) for verification when the user installs the MFP application file 301 in the MFP 101 by using the MFP application installer that operates on the PC 102.

The first verification is performed by the application function unit 209 of the MFP 101 by using the cryptographic processing function unit 215. According to the first verification, the MFP application file 301 to be installed is determined whether it is issued by a qualified application issuer.

The second electronic signature 306 is used for verification by the MFP application installer when the installation operator registers the MFP application file 301 in the MFP application installer that operates on the PC 102. The EULA and the setting parameter unit of the MFP application file 301 to be installed are verified in the second verification.

Before installing the application in the MFP 101, the MFP application installer determines in advance on the PC 102 whether the second EULA and the setting parameter unit 305 are issued by a qualified application issuer.

When installing the MFP application 103 of the present exemplary embodiment, the installation operator can confirm the EULA and set various parameters of the application before the MFP 101 to which the application is to be installed is accessed. Confirmation of the EULA and setting of the application parameter are performed when the installation operator registers the MFP application 103 in the PC 102.

When the MFP application 103 is registered, the MFP application installer verifies the EULA and the setting parameter unit 305 by using the second electronic signature 306. If the verification using the second electronic signature 306 is successful, the installation operator determines that the EULA and the various setting parameters are those generated by the issuer of the MFP application 103.

In other words, according to the verification of the MFP application installer, the installation operator can detect whether the second EULA and the setting parameter unit 305 of the MFP application 103 are interpolated by a third person. The MFP application according to the present exemplary embodiment can set a value to the application parameter before the installation operator installs the application in the MFP 101.

Thus, according to the processing of the present exemplary embodiment, confirmation of an unintended EULA by the user can be prevented. This is because interpolation of the EULA and the application parameter unit by a third person can be prevented.

Further, according to the processing of the present exemplary embodiment, setting of an unintended application parameter by the application issuer, for example, setting of a value greater than an assumed range of values, can be prevented. In other words, according to the processing of the present exemplary embodiment, confirmation of EULA and setting of an unintended application parameter value can be prevented before the MFP application 103 is installed in the MFP 101.

### <MFP Application Installer on PC 102>

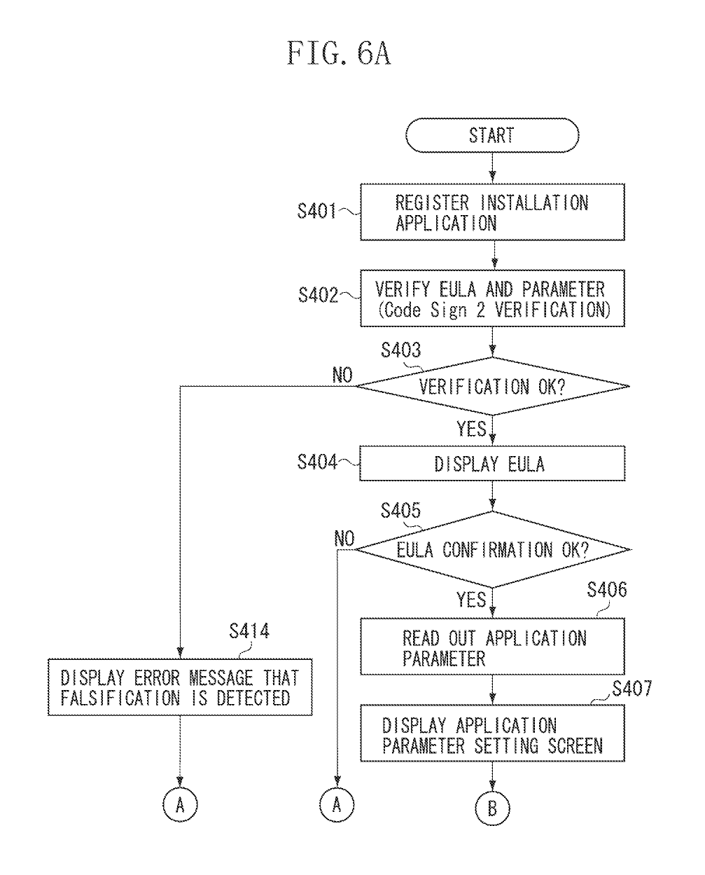

FIG. 6 is a flowchart illustrating an example of processing performed by the MFP application installer that operates on the PC 102. An issuer of the MFP application 103 assigns the first and the second electronic signatures to the MFP application 103 and performs encryption.

A public key for electronic signature verification used for verifying the second electronic signature 306 in X.509 digital certificate is embedded in advance in the MFP application installer. The installation operator uses the MFP application installer that operates on the PC 102 when the installation operator installs the MFP application 103 in the MFP 101.

In step S401, the installation operator registers the MFP application 103 to be installed in the MFP application installer.

The MFP application installer retrieves the second EULA, the setting parameter unit 305, and the second electronic signature 306 of the MFP application 103 which has been registered. The MFP application installer determines whether the retrieved second electronic signature 306 is a valid X.509 certificate by using a public key for electronic signature verification embedded in advance in the application installer.

If the MFP application installer determines that the certificate is valid, in step S402, the MFP application installer verifies a hash value of the second EULA and the setting parameter unit 305 by using the second electronic signature 306.

In step S403, the MFP application installer determines whether the second EULA and the setting parameter unit 305 are determined as valid as a result of the verification in step S402. As a result of the verification in step S402, if the MFP application installer determines that the second EULA and the setting parameter unit 305 are valid (YES in step S403), the processing proceeds to step S404. In step S404, the MFP application installer displays an EULA document on the screen and prompts the installation operator to confirm the EULA.

On the other hand, if the MFP application installer determines that the second EULA and the setting parameter unit 305 are not valid (NO in step S403), the processing proceeds to step S414. In step S414, the MFP application installer displays a message informing that fraud such as interpolation is detected with respect to the EULA and the parameter unit included in the MFP application 103. Then, the processing in FIG. 6 ends.

If the EULA is displayed by the MFP application installer and the EULA is confirmed by the installation operator, it means that a valid EULA in the MFP application 103 is confirmed by the installation operator.

In step S405, the MFP application installer determines whether the installation operator has confirmed the EULA. If the installation operator confirms the EULA which has been displayed and if the MFP application installer detects that a button such as an OK button has been pressed (YES in step S405), the processing proceeds to step S406.

In step S406, the MFP application installer reads out the setting parameter schema being an example of definition information of parameter values from the second EULA and the setting parameter unit 305. In step S407, the MFP application installer displays a screen used for setting various parameters according to the setting parameter schema which has been read out and prompts the installation operator to set the application parameter.

On the other hand, in step S405, if the installation operator confirms the EULA which has been displayed, and if the MFP application installer detects that a button such as a NG button has been pressed (NO in step S405), the processing in FIG. 6 ends.

In step S408, the MFP application installer verifies the parameter value set by the installation operator based on the setting parameter schema. The processing in step S408 is an example of processing used for the confirmation of the validity of the parameter value (validity confirmation processing). In step S409, the MFP application installer determines whether the parameter value which has been set is appropriate as a result of the verification performed in step S408.

If the MFP application installer determines that the parameter value which has been set is appropriate (YES in step S409), the processing proceeds to step S410. In step S410, the MFP application installer outputs the parameter value which has been set as a setting file in XML format.

On the other hand, if the MFP application installer determines that the parameter value which has been set is not appropriate (NO in step S409), the processing proceeds to step S415. In step S415, the MFP application installer displays an error message informing that the parameter value is not appropriate. Then, the processing in FIG. 6 ends.

Since the parameter value is set by the installation operator and confirmed by the MFP application installer, it is determined that the installation operator has set an effective value to a valid parameter in the MFP application 103 without fraud such as interpolation. This helps prevent a third person from setting an inaccurate or fraudulent parameter value not intended by the creator of the MFP application 103.

The creator of the MFP application 103 can constrain the parameter to be set by using a constraining facet of the XML schema. According to the constraint of the parameter by the creator of the MFP application 103 and the confirmation of the parameter by the installation operator when the installation operator installs the application, false operation of the MFP application 103 caused by an interpolated parameter value can be prevented.

In step S411, the MFP application installer transmits the MFP application 103 and the setting file written in the XML format to the MFP 101. In step S412, the MFP application installer determines whether the installation has been successfully completed.

If the MFP 101 returns a message that the installation of the application has been successful (YES in step S412), the processing proceeds to step S413. On the other hand, if the MFP 101 returns a message that the installation of the application has not been successful (NO in step S412), the processing proceeds to step S416.

In step S413, the MFP application installer displays a message informing that the installation has been completed. Then, the processing in FIG. 6 ends. In step S416, the MFP application installer displays a message informing that the installation has failed. Then, the processing in FIG. 6 ends.

### <Setting Parameter Schema for Various Parameters>

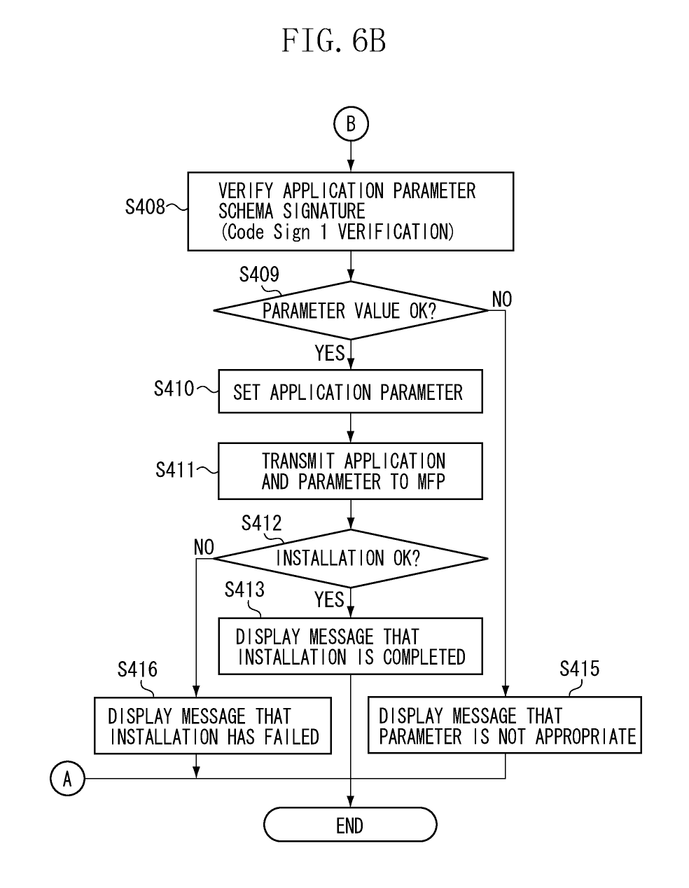

FIG. 7 illustrates an example of the setting parameter schema of the second EULA and the setting parameter unit 305 for various setting parameters. The style of the schema is according to W3C XML Schema 1.1 specification. According to the present exemplary embodiment, the number of users who can simultaneously use the MFP application 103 is limited.

The number of users that can simultaneously use the MFP application is defined by the schema according to a user-derived data type of a simple type. Further, according to this schema, due to a constraining facet of the numerical value, the number of users that can simultaneously use the application is from 1 to 99.

The constraining facet which can be used is a facet included in XML Schema 1.1 specification. Such facet is, for example, a facet using a numerical value such as a maximum or a minimum value, a facet using a character string, or a regular expression using a pattern facet.

The MFP application installer verifies the schema when the MFP application 103 is installed in the MFP 101 by the MFP application installer that operates on the PC 102 illustrated in the flowchart in FIG. 6. At that time, the MFP application installer executes the processing from steps S402 to S409 in the flowchart in FIG. 6.

By the MFP application installer verifying the second EULA and the setting parameter unit 305 by the second electronic signature 306, the correctness of the schema itself is guaranteed.

Further, when the number of users that can simultaneously use the application is set by the installation operator, the MFP application installer verifies the schema. Thus, it is guaranteed that the value set by the installation operator is in the range of 1 to 99 indicated by the schema.

### <Setting File (Instance) in XML Format>

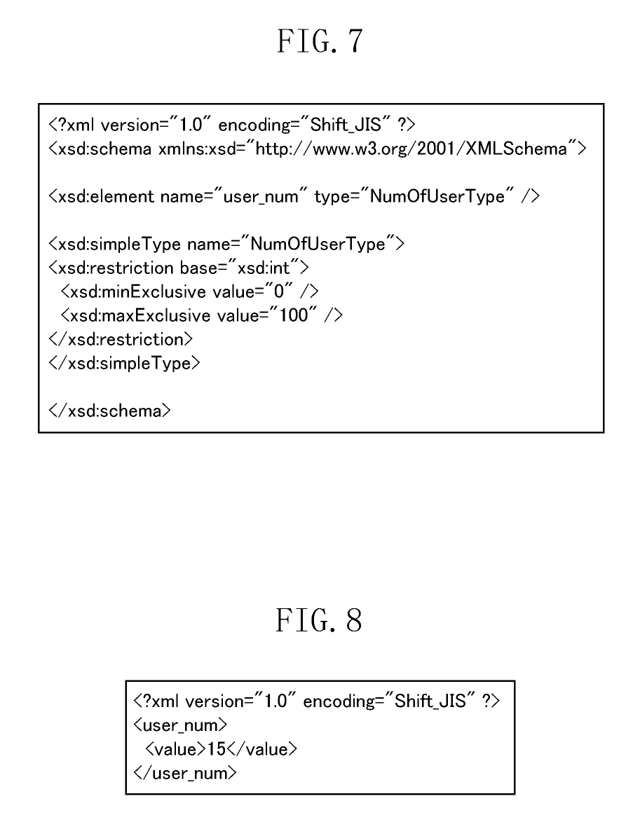

FIG. 8 is an example of the setting file (instance) in XML format output in step S410 by the MFP application installer when the installation operator sets the maximum number of simultaneously connected users to 15. This document is transmitted to the MFP 101 together with the MFP application 103 by the MFP application installer in step S411 in FIG. 6.

<Installer that Operates on MFP 101>

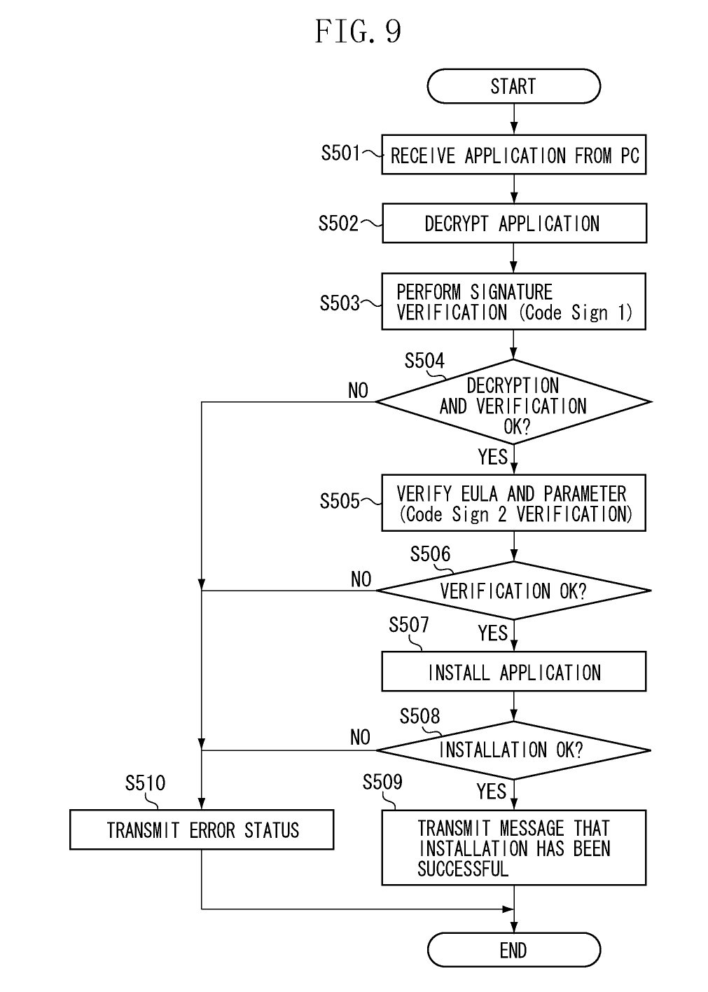

FIG. 9 is a flowchart of an example of processing performed by the installer that operates on the MFP 101. The installer that operates on the MFP 101 is one function of the application function unit 209 illustrated in FIG. 4. By using the network function unit 206 and the cryptographic processing function unit 215, the installer that operates on the MFP 101 installs the MFP application 103.

In step S501, the installer that operates on the MFP 101 receives the MFP application 103 and the setting file illustrated in FIG. 8 from the PC 102. In step S502, the installer that operates on the MFP 101 decrypts the signature encryption program main unit 302 of the MFP application file 301 of the MFP application 103 by a decryption key embedded in advance in the cryptographic processing function unit 215.

The installer that operates on the MFP 101 calculates a hash value of the hash value calculation object unit 303 of the signature encryption program main unit 302 decrypted in step S502. In step S503, the installer that operates on the MFP 101 performs signature verification of the hash value calculation object unit 303 by using the first electronic signature 304. In step S504, the installer that operates on the MFP 101 determines whether the decryption in step S502 has been successful and whether the hash value calculation object unit 303 is valid as a result of the signature verification in step S503.

If the decryption is successful and if the hash value calculation object unit 303 is determined that it is valid (YES in step S504), the processing proceeds to step S505. On the other hand, if the decryption fails or the hash value calculation object unit 303 is determined that it is not valid (NO in step S504), the processing proceeds to step S510.

In step S505, the installer that operates on the MFP 101 performs signature verification of the second EULA and the setting parameter unit 305 located out of the signature encryption program main unit by using the second electronic signature 306. The processing in step S505 is an example of correctness confirmation processing. If the processing proceeds from step S504 to step S510, in step S510, the installer that operates on the MFP 101 transmits an error status and a message informing that the first signature verification has failed to the PC 102. Then, the processing in FIG. 9 ends.

In step S506, the installer that operates on the MFP 101 determines whether the second EULA and the setting parameter unit 305 are determined that they are valid as a result of verification in step S505. If the second EULA and the setting parameter unit 305 are determined that they are valid as a result of the verification in step S505 (YES in step S506), the processing proceeds to step S507.

On the other hand, as a result of the verification in step S505, if the second EULA and the setting parameter unit 305 are determined that they are not valid (NO in step S506), the processing proceeds to step S510.

The processing in step S505 is performed so as to confirm whether the EULA and the application parameter schema verified by the MFP application installer that operates on the PC 102 and confirmed by the installation operator are correct.

Since the EULA and the application parameter schema verified in step S402 of the flowchart in FIG. 6 and confirmed by the installation operator may be interpolated before they are transferred to the MFP 101, the installer that operates on the MFP 101 further confirms the EULA and the various application parameters transferred from the PC 102.

In step S507, the installer that operates on the MFP 101 installs the MFP application 103 to which the value in FIG. 8 has been set by the application function unit 209. The MFP application 103 runs on the MFP 101 (image processing apparatus) and its behavior can be changed according to a value of the parameter that is set. If the processing proceeds from step S506 to step S510, the installer that operates on the MFP 101 transmits an error status regarding a second signature verification failure and a message to the PC 102. Then, the processing in FIG. 9 ends.

In step S508, the installer that operates on the MFP 101 determines whether the installation of the application in step S507 has been successful. If the installation of the application has been successful (YES in step S508), the processing proceeds to step S509. On the other hand, if the installation of the application has failed (NO in step S508), the processing proceeds to step S510.

In step S509, the installer that operates on the MFP 101 transmits a status indicating that the installation has been successful and a message to the PC 102. Then the processing in FIG. 9 ends. If the processing proceeds from step S508 to S510, the installer that operates on the MFP 101 transmits a status indicating that the installation has failed, and a message to the PC 102. Then the processing in FIG. 9 ends.

According to the configurations of the present exemplary embodiment, the installation operator installs the MFP application 103 in the MFP 101 together with a setting file. Thus, the MFP application 103 can be activated as an application whose network setting and application parameter setting is finished from the first time it is started after the installation. Further, according to the configurations of the present exemplary embodiment, a parameter value of the application can be set before the installation.

Thus, the installation operator can reduce the time and effort which is necessary in setting up a great number of MFPs, and occurrence of setting errors after the application is installed by the MFP operator can be prevented. Further, arbitrary change in a schema of a value concerning setting of a parameter is prevented. Thus, the values can be set within the range of the parameter values determined in advance.

Further, according to the configuration of the present exemplary embodiment, since the installer that runs on the PC 102 performs the verification, the number of times of the verification necessary in installing an application with a parameter in many MFPs can be only once.

Further, according to the configuration of the present exemplary embodiment, the public key for the electronic signature verification is different from the key for the MFP 101. Thus, the verification can be performed without assigning a key for the MFP 101 to the installer that operates on the PC 102.

Further, the above-described exemplary embodiments can also be achieved by supplying a software program that realizes each function of the aforementioned exemplary embodiments to a system or an apparatus via a network or various types of storage media, and a computer (or a CPU or a MPU) in the system or the apparatus reads and executes the program stored in such storage media.

According to each of the above-described exemplary embodiments, installation operation of the installation operator can be simplified and interpolation of a range of values set for the parameter of the application to be installed by a third person can be prevented.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-106474 filed May 6, 2010, which is hereby incorporated by reference herein in its entirety.

What is claimed is:

1. An information processing apparatus comprising:
a confirmation unit configured to confirm, when application data including a parameter of an application with definition information of a value of a parameter and an encrypted application whose behavior can be changed according to the value of the parameter and operates on an image processing apparatus are registered, correctness of the definition information included in the application data;
a display unit configured to, if correctness of the definition information is confirmed by the confirmation unit, display a screen used by an installation operator of the application for setting the value to the parameter according to the definition information;
a validity confirmation unit configured to confirm validity of the value of the parameter based on the definition information if the value is set to the parameter via the screen; and
a transmission unit configured to transmit the application data and the value of the parameter if validity of the value of the parameter is confirmed by the validity confirmation unit.

2. The information processing apparatus according to claim 1, wherein license agreement information of the application is further included in the application data;
wherein if the application data is registered, the confirmation unit confirms correctness of the definition information and the license agreement information;
wherein if the correctness of the definition information and the license agreement information is confirmed by the confirmation unit, the display unit displays a screen used by the installation operator of the application in confirming the license agreement information, and if the license agreement information is confirmed via the screen, displays a screen used by the installation operator of the application in setting the value to the parameter according to the definition information.

3. The information processing apparatus according to claim 1, wherein the application data includes electronic signature information for confirming correctness of the definition information;
wherein the confirmation unit performs confirmation of correctness of the electronic signature information by using a public key set in advance, and if correctness of the electronic signature information is confirmed, confirms correctness of the definition information by using the electronic signature information.

4. The information processing apparatus according to claim 1, further comprising an error displaying unit configured to display a message informing that interpolation of the definition information has been detected if the correctness of the definition information is not confirmed by the confirmation unit.

5. The information processing apparatus according to claim 1, further comprising an error displaying unit configured to display a message informing that the value of the parameter is fraudulent if the validity of the value of the parameter is not confirmed by the validity confirmation unit.

6. An application installation system including an information processing apparatus and an image processing apparatus, the information processing apparatus comprising:
a confirmation unit configured to confirm, when application data including a parameter of an application with definition information of a value of a parameter and an encrypted application whose behavior can be changed according to the value of the parameter and operates on an image processing apparatus are registered, correctness of the definition information included in the application data;
a display unit configured to, if the correctness of the definition information is confirmed by the confirmation unit, display a screen used by an installation operator of the application for setting the value to the parameter according to the definition information;
a validity confirmation unit configured to confirm validity of the value of the parameter based on the definition information if the value is set to the parameter via the screen; and
a transmission unit configured to transmit the application data and the value of the parameter if validity of the value of the parameter is confirmed by the validity confirmation unit,
wherein the image processing apparatus comprises:
a receiving unit configured to receive the application data and the value of the parameter from the information processing apparatus;
a decryption unit configured to decrypt the encrypted application included in the application data received by the receiving unit; and
an installation unit configured to set the value of the parameter received by the receiving unit to the application decrypted by the decoding unit, and install the application.

7. The installation system according to claim 6, wherein the application data includes electronic signature information used for confirming the correctness of the definition information;
wherein the confirmation unit performs confirmation of correctness of the electronic signature information by using a public key set in advance, and if correctness of the electronic signature information is confirmed, confirms correctness of the definition information by using the electronic signature information,
wherein the image processing apparatus further includes a correctness confirmation unit configured to confirm correctness of the definition information included in the application data by using the electronic signature information included in the application data received by the receiving unit, and
wherein if the correctness of the definition information is confirmed by the correctness confirmation unit, the installation unit sets the value of the parameter received by the receiving unit to the application decrypted by the decryption unit and installs the application.

8. An information processing method executed by an information processing apparatus, the method comprising:
confirming correctness of the definition information included in the application data when application data including a parameter of an application with definition information of a value of a parameter and an encrypted application whose behavior can be changed according to the value of the parameter and operates on an image processing apparatus are registered;
displaying a screen used by an installation operator of the application for setting the value to the parameter according to the definition information if correctness of the definition information is confirmed by the confirmation;
confirming validity of the value of the parameter based on the definition information if the value is set to the parameter via the screen; and
transmitting the application data and the value of the parameter if validity of the value of the parameter is confirmed by the validity confirmation unit.

9. An installation method of an installation system of an application including an information processing apparatus and an image processing apparatus, the method comprising:
confirming, by the information processing apparatus, when application data including a parameter of an application with definition information of a value of a parameter and an encrypted application whose behavior can be changed according to the value of the parameter and operates on an image processing apparatus are registered, correctness of the definition information included in the application data;
displaying, by the information processing apparatus, if correctness of the definition information is confirmed, a screen used by an installation operator of the application for setting the value to the parameter according to the definition information; and
confirming, by the information processing apparatus, validity of the value of the parameter based on the definition information if the value is set to the parameter via the screen and, transmitting the application data and the value of the parameter if validity of the value of the parameter is confirmed by the validity confirmation unit; and
receiving, by the image processing apparatus, the application data and the value of the parameter from the information processing apparatus;
decrypting, by the image processing apparatus, the encrypted application included in the application data received by the receiving unit; and
setting, by the image processing apparatus, the value of the parameter received by the receiving unit to the application decrypted by the decoding unit and installing the application.

10. A non-transitory computer-readable storage medium containing computer-executable instructions for causing a computer to execute operations including:
confirming correctness of the definition information included in the application data, when application data including a parameter of an application with definition information of a value of a parameter and an encrypted application whose behavior can be changed according to the value of the parameter and operates on an image processing apparatus are registered;
displaying a screen used by an installation operator of the application for setting the value to the parameter according to the definition information if the correctness of the definition information is confirmed by the confirmation;
confirming validity of the value of the parameter based on the definition information if the value is set to the parameter via the screen; and
transmitting the application data and the value of the parameter if validity of the value of the parameter is confirmed by the validity confirmation unit.
